(19) United States
(12) Patent Application Publication
(10) Pub. No.: US 2006/0162749 A1
(43) Pub. Date: Jul. 27, 2006

(54) Cleaning device for a hair removing apparatus

(76) Inventors: Atsuhiro Saito, Hikone-shi (JP); Koji Osada, Osaka-shi (JP); Jyuzaemon Iwasaki, Nagahama-shi (JP); Hiroyuki Kameoka, Hikone-shi (JP); Yasuo Ibuki, Hikone-shi (JP); Fumio Taniguchi, Hikone-shi (JP); Kotaro Yanagi, Hikone-shi (JP); Hiroshi Shigeta, Fujiidera-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/525,206

(22) PCT Filed: Jan. 19, 2004
(86) PCT No.: PCT/JP04/00383

§ 371 Date: Feb. 22, 2005

(30) Foreign Application Priority Data
Jan. 21, 2003 (JP) 2003-012811

(51) Int. Cl. B08B 3/00

(52) U.S. Cl. 134/111; 134/166 R; 134/184; 134/186

(57) ABSTRACT

A cleaning device has a basin that receives an operator head of the hair removing apparatus, a tank storing a volume of a cleaning liquid, and a pump supplying the liquid from the tank to the basin for cleaning the operator head. A drip pan is formed separately from the tank and is disposed underneath the basin for collecting the liquid dripping from the basin as well as contaminants dislodged from the operator head. The drip pan is connected to the tank so as to return the liquid from within the drip pan to the tank under the action of the pump. A filter is provided in the drip pan for removing the contaminants from the liquid so that the filter can be cleaned or replaced without involving the tank and the liquid contained therein.

### TECHNICAL FIELD

The present invention is directed to a cleaning device for a hair removing apparatus, particularly a dry shaver with the use of a cleaning liquid.

### BACKGROUND ART

U.S. Pat. No. 6,263,890 shows a cleaning device for a dry shaver. The device is formed with a basin for accommodating therein a shaver head of the shaver, and a tank containing a volume of a cleaning liquid and communicating with the basin through a liquid supply channel. A pump is disposed in the liquid supply channel in order to supply the liquid from the tank into the basin for cleaning the shaver head, i.e., cutters and the associated parts. The tank is disposed immediately below the basin for collecting the liquid from the basin by gravity feed. A filter is fixed within the tank in order to separate contaminants or hairs dislodged from the head and carried by the circulating liquid for preventing the contaminants from entering the pump. When the filter is clogged, it has to be discarded together with the tank and therefore a large volume of the liquid contained in the tank.

U.S. Pat. No. 5,711,328 suggests another cleaning device in which a drip pan is disposed immediately below the basin to receive the liquid dripped from the basin. The liquid is fed back to a separate tank holding a large volume of the tank. A pump is included to circulate the liquid through the tank, the basin and the drip pan. Also in this device, the filter is fixed within the tank so as to supply the clean liquid from the tank into the basin. However, since the filter is fixed to tank, the filter cannot be cleaned or replaced without discarding the tank, i.e., the large volume of the liquid contained in the tank. This is inconvenience and even uneconomical in that the liquid cannot be reused.

### DISCLOSURE OF THE INVENTION

The present invention has been accomplished in view of the above problem and provides an improved cleaning device for a hair removing apparatus. The cleaning device includes a housing provided with a basin that receives an operator head of the hair removing apparatus, a tank storing a volume of a cleaning liquid, and a pump supplying the liquid from the tank to the basin for cleaning the operator head. A drip pan is formed separately from the tank and is disposed underneath the basin for collecting the liquid dripping from the basin. The drip pan is connected to the tank by way of a fluid intake channel for allowing the liquid to return from within the drip pan to the tank under the action of the pump. The drip pan is open to the bottom of the basin for collecting the hairs or contaminants dislodged from the operator head. The feature of the present invention resides in that a filter is provided in the drip pan for removing the contaminants from the liquid. Thus, the filter can be cleaned or replaced without involving the tank and the liquid contained therein, enabling a continued use of the tank and the cleaning liquid and therefore assuring economical cleaning of the apparatus.

In a preferred embodiment, the drip pan is separated by the filter into a first chamber which is in direct communication with the basin and a second chamber having a connection port for direct connection with the fluid intake channel. The connection port is designed to have a flow cross area smaller than the surface area of the filter so as to smoothly pass the liquid through the filter without rapidly clogging the filter.

The second chamber is preferred to communicate with an air vent that is formed in the housing and is open to the atmosphere not through the filter for introducing the air. The tank is provided in the form of a hermetically sealed container which is selectively open to the atmosphere by way of an air valve. The device includes a controller that selectively provides a supply mode for supplying the liquid to the basin from the tank and a recovery mode for recovering the liquid from the basin to the tank. In the supply mode, the pump is actuated while the air valve is kept closed so as to feed the air introduced through the air vent and the second chamber into to the tank by way of the fluid intake channel and therefore accumulate the air pressure within the tank, thereby forcing the liquid out of the tank to the basin. In the recovery mode, the pump is actuated while the air valve is kept opened so as to feed the liquid out from the basin through the fluid intake channel to the tank without accumulating the air pressure within the tank, thereby collecting the liquid into the tank. With the provision of the recovery mode, the liquid can be completely recovered into the tank to empty the drip pan, thereby facilitating the cleaning or replacement of the filter.

Most preferably, the drip pan is removably received within a recess formed in the housing below the basin so that the drip pan and the filter can be easily washed or cleaned for continued use.

The filter may be designed to have an upper area and a lower area so that the upper area is positioned above a level of the liquid dripped and stored into the drip pan for introducing the air through the upper area into the second chamber. Thus, the outside air can be successfully drawn by the pump not through the liquid phase into the tank, while the filter can entrap hairs or contaminants possibly carried by the air.

The second chamber of the drip pan may have an inner bottom which is inclined downwardly to the connection port for facilitating the liquid flow to the tank, particularly in the recovery mode, for complete collection of the liquid into the tank.

Preferably, the drip pan is configured to have a liquid storing capacity larger than that of the basin. Thus, even if the pump stops during the supply mode, the drip can collect the whole volume of the liquid from the basin without causing any leakage around the drip pan.

The device may include a monitor that monitors whether or not the drip pan is attached to the housing so that the controller deactivates the pump in response to the drip pan being detached from the housing, assuring safe operation of the device.

Instead of providing the removable drip pan, the filter itself may be made removable from the housing to be easily cleaned. Also in this case, the controller may be arranged to deactivate the pump in response to the filter being detached from the housing.

These and still other advantageous features of the present invention will become more apparent from the following detailed description of the embodiment when taken in conjunction with the attached drawings.

### BRIEF DESCRIPTION OF THE DRAWINGS

FIG. 1 is a perspective view of a cleaning system shaver in accordance with a preferred embodiment of the present invention;

FIG. 2 is a schematic view illustrating the operation of the above system;

FIG. 3 is a rear perspective view of the system in a rather schematic representation;

FIG. 4 is a front view of a dry shaver of the above system;

FIG. 5 is a circuit block diagram of the above device illustrating the operation of the above system;

FIG. 6 is a front perspective view of the above system with the dry shaver being removed therefrom;

FIGS. 7 and 8 are vertical sections of the above system, respectively with and without the shaver;

FIG. 9 is another vertical section of the above system;

FIG. 10 is a rear vertical section of the above system;

FIG. 11 is a front view of the above system;

FIG. 12 is a vertical section of a detachable tank utilized in the above system;

FIG. 13 is a top view of a drip pan utilized in the above system;

FIG. 14 is a vertical section of the drip pan;

FIG. 15 is a partial section showing a bottom of the drip pan and the associated portion of the device's housing; and

FIG. 16 is a vertical section of a modified drip pan.

### BEST MODE FOR CARRYING OUT THE INVENTION

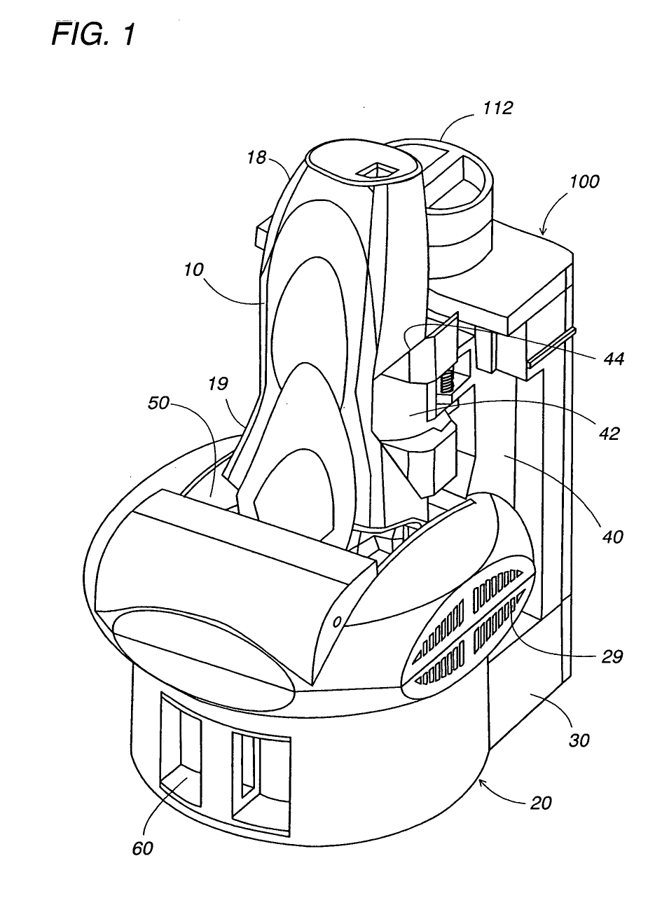

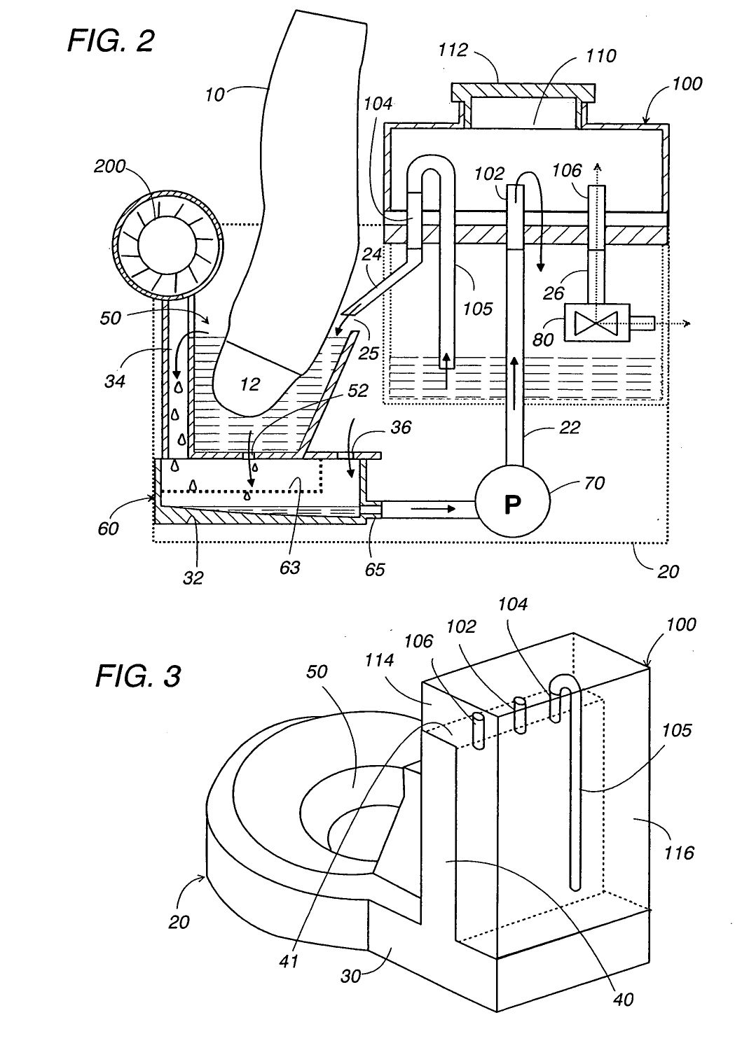

Referring now to FIGS. 1 and 2, there is shown a cleaning device for cleaning a hair removing apparatus, for example, a dry shaver 10 or epilator with the use of a cleaning liquid. The device has a housing 20 with a base 30 and a stand 40 upstanding from a rear end of the base. Formed at the front end of the base 30 is a basin 50 which is configured to receive an operator head, i.e., a shaver head 12 of the shaver 10. The cleaning liquid is stored in a tank 100 detachably mounted to the stand 40 and is connected to the basin 50 for supplying the liquid into the basin and for recovering the liquid therefrom. The device includes a pump 70 which is controlled to circulate the cleaning liquid between the tank 100 and the basin 50 for cleaning the shaver head 12. The cleaning operation continues for a predetermined period. Thereafter, a control is made to collect the liquid from the basin 50 into the tank 100, details of which will be discussed later. Upon recovery of the liquid into the tank, a fan 200 is actuated to produce a forced air flow over the head 12 for drying the same.

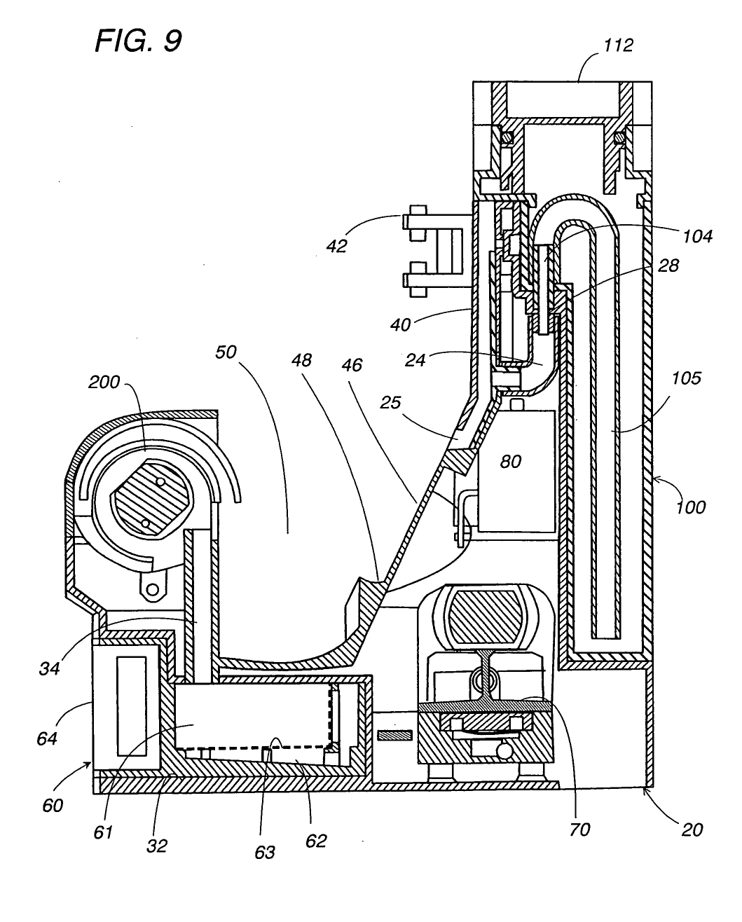

As shown in FIG. 2, a drip pan 60 is disposed immediately below the basin 50 for collecting the liquid dripping and/or overflowing from the basin 50. The drip pan 60 has a top opening which communicates with a drain port 52 at the bottom center of the basin 50, and also with an overflow duct 34 leading to an upper edge of the basin 50. The drip pan 60 has a filter 63 for entrapping hairs or contaminants dislodged from the shaver head 12 and carried by the liquid dribbling through the drain port 52 into the drip pan 60. The liquid thus cleared of the contaminants is fed through a connection port 65 to a fluid intake channel 22 leading to the tank 100. The pump 70 is disposed in the fluid intake channel 22 for drawing the liquid from the basin 50. The fluid intake channel 22 is open to the atmosphere through the drain port 52, the overflow duct 34, and also through an air vent 36 formed in the base 30 around the basin 50. Thus, depending upon the level of the liquid in the basin 50, the outside air is drawn alone or together with the liquid by the action of the pump 70 into the tank 100 through the fluid intake channel 22. The tank 100 is provided in the form of a hermetically sealed container having an inlet and an outlet. The inlet is defined by a fluid inlet tube 102 which is detachably connected to the fluid intake channel 22 for taking in the liquid and/or the air. The outlet is defined by a liquid outlet tube 104 which is detachably connected to a liquid supply channel 24 formed in the housing 20 and leading to a spout 25 upwardly of the basin 50, as best shown in FIG. 9, for flowing the liquid down into the basin 50. Turning back to FIG. 2, the liquid outlet tube 104 is connected to a U-shaped sucking tube 105 which extends deep into the tank 100 to a point adjacent to the bottom of the tank for sucking the liquid. Further, the tank 100 is formed with an air exhaust tube 106 detachably connected to an air exhaust channel 26 which extends within the housing 20 and is open to the atmosphere through ventilation windows 29 or clearances in the walls of the housing 20. An air valve 80 is disposed in the air exhaust channel 26 to selectively close the tank and open it to the atmosphere. The air valve 80 is realized by a normally-closed electromagnetic valve which opens upon being energized or supplied with an electric current. A cap 112 is detachably and sealingly mounted in a filling port 110 in the upper end of the tank 100 for replacing or replenishing the liquid.

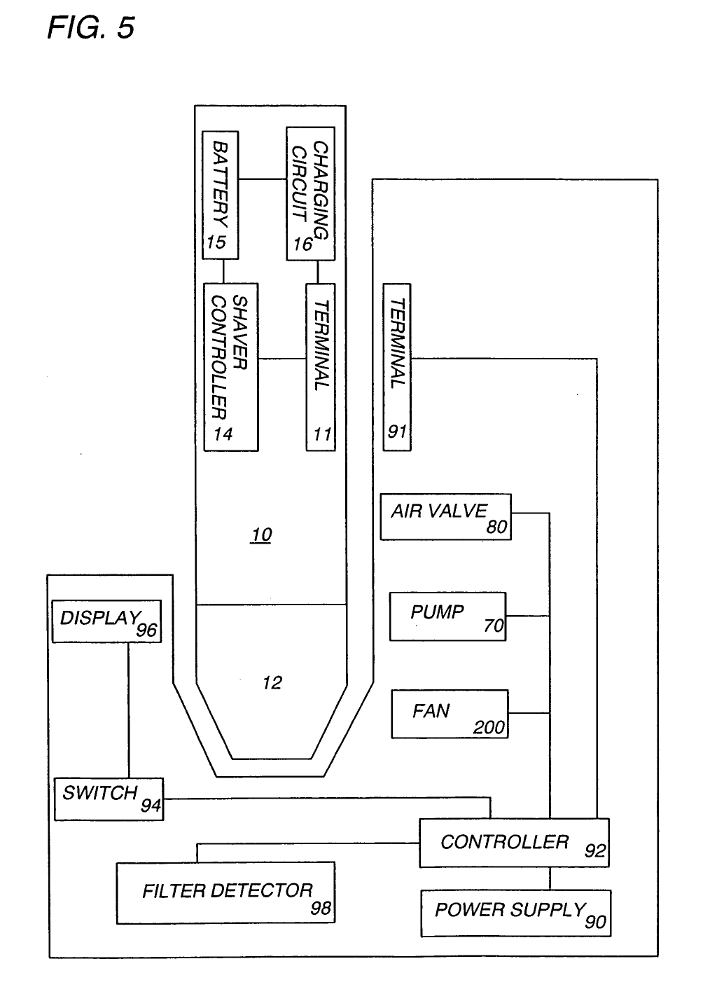

Now, the operation of the device is discussed with reference to FIGS. 2 and 5. The device includes a power supply 90 providing an electric power to various electrical parts, and a controller 92 responsible for controlled operations of the associated parts. When a switch 94 is activated, the controller 92 responds to provide a supply mode and a recovery mode in sequence. In the supply mode, the pump 70 is activated with the air valve 80 being kept closed, i.e., the tank being kept hermetically sealed. Initially, the basin 50 is substantially free from the liquid such that only the air is drawn and accumulated in the tank 100 to increase the inside air pressure. As the air pressure increases, the liquid in the tank 100 is forced to expel out through the liquid outlet tube 104 and the liquid supply channel 24 into the basin 50. In this connection, it is noted that the drain port 52 of the basin 50 is dimensioned such that the flow rate of the liquid dripping into the drip pan 60 is smaller than that of the liquid being supplied from the tank 100, thereby increasing the amount of the liquid in the basin 50. After the basin 50 is filled with the liquid, an extra amount of the liquid is caused to overflow into the drip pan 60, maintaining the liquid in the basin 50 at a constant level. In this connection, the air is continuously drawn into the tank with the superfluous liquid to keep supplying the liquid into the basin 50, i.e., circulating the liquid between the tank 100 and the basin 50 for cleaning the shaver head 12. The supply mode continues over a predetermined time period during which the shaver head is activated intermittently or continuously to shake the contaminants off, enhancing the cleaning effect.

The supply mode is automatically followed by the recovery mode in which the pump 70 is activated with the air valve 80 kept opened to collect the liquid from the basin 50 through the drip pan 60 into the tank 100. With the air valve 80 being opened, i.e., the tank 100 opened to the atmosphere, the air drawn by the pump 70 is exhausted through the air valve 80 so as to recover the liquid and collect only the liquid in the tank 100. The recovery mode continues over a predetermined time period to collect the whole liquid into the tank. Near the end of the period, the shaver head is controlled to be activated for shaking the liquid off. Thereafter, the fan 200 is activated to dry the shaver head with or without the shaver head being actuated. Thus, the supply mode and the recovery mode are accomplished with the use of a single pump and the air valve.

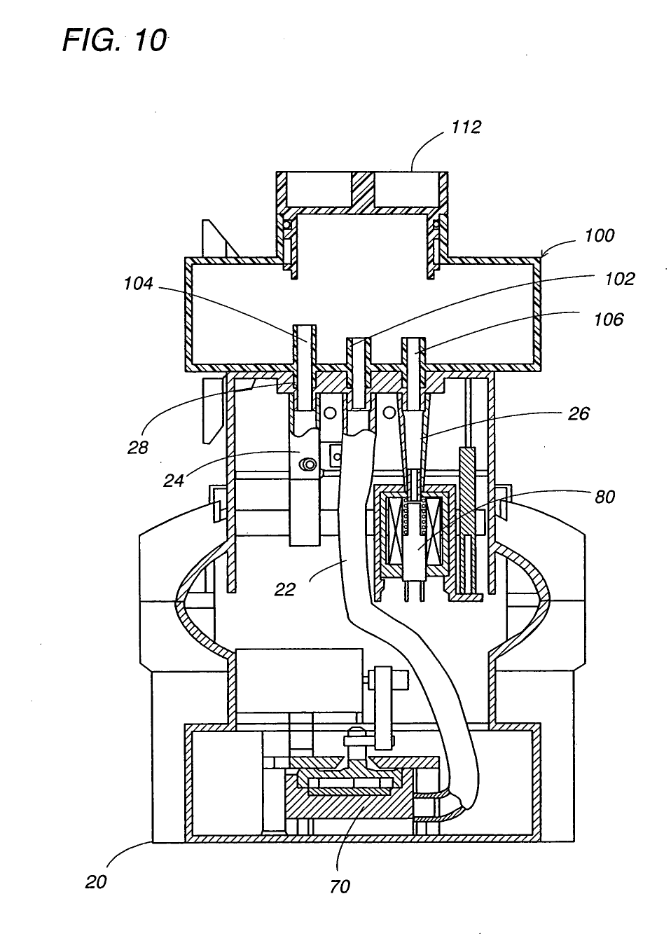

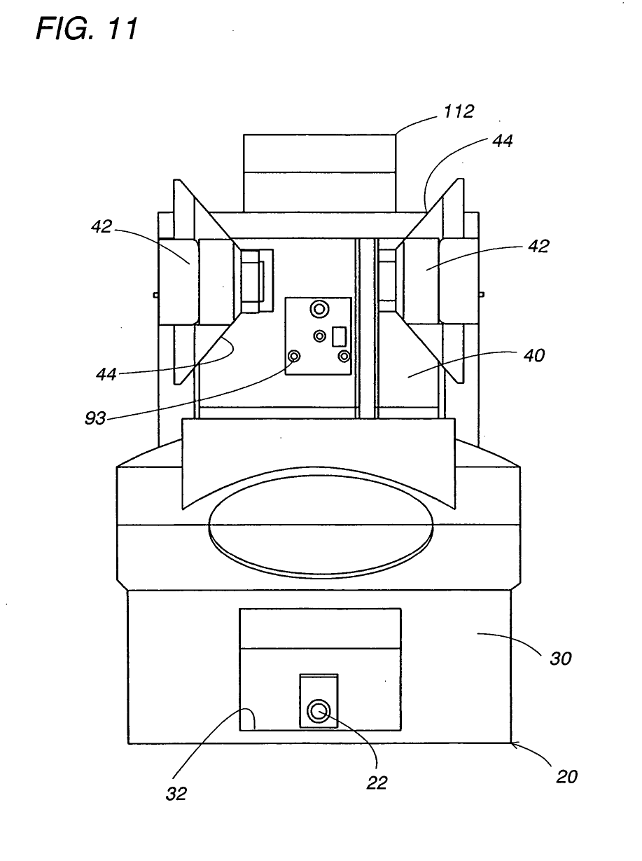

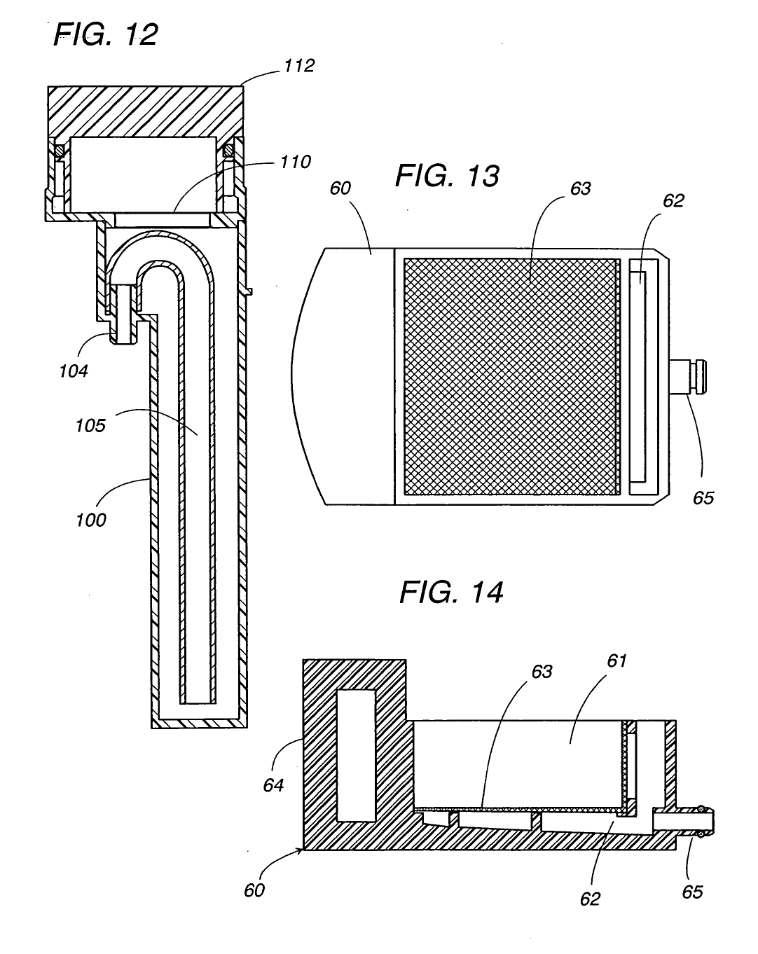

As schematically shown in FIG. 3, the tank 100 is L-shaped to have a wide header section 114 and a vertically elongated section 116 overlapping the rear face of the stand 40. The tank 100 is mounted on the housing 20 with the horizontal section 114 resting on a mounting face 41 on top of the stand 40. The fluid inlet tube 102, the liquid outlet tube 104, and the air exhaust tube 106 are integrally formed with the tank 100 to project on the bottom of the header section 114 for detachably connection with the fluid intake channel 22, the liquid supply channel 24, and the air exhaust channel 26, respectively. For this purpose, the ends of the channels 22, 24, and 26 are integrated into a combination socket 28 formed in the mounting face 41, as shown in FIG. 10. Thus, the tank 100 can be attached to the housing 20 from the above.

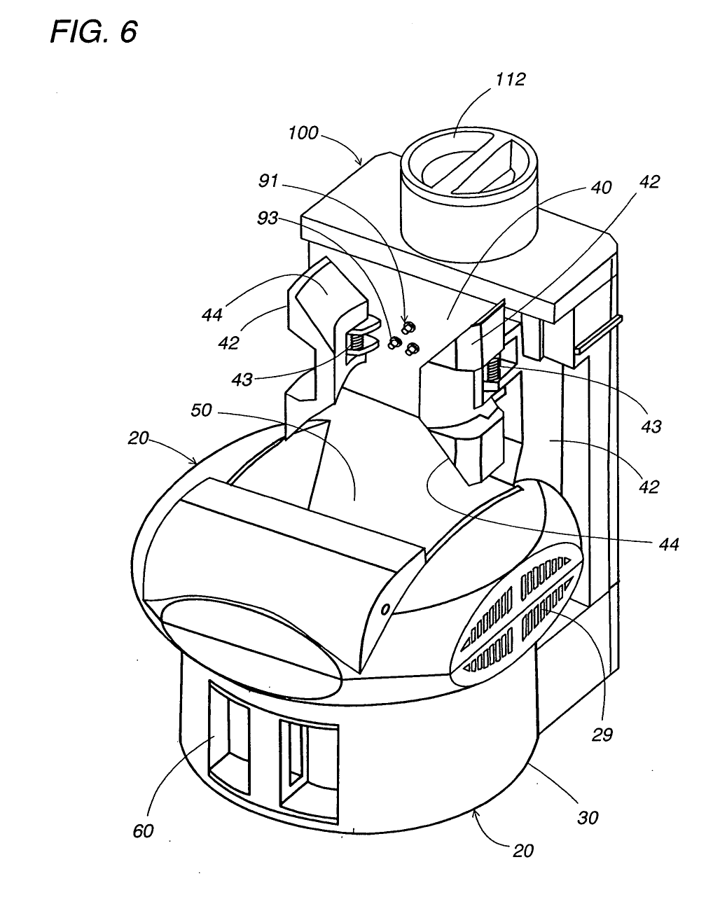

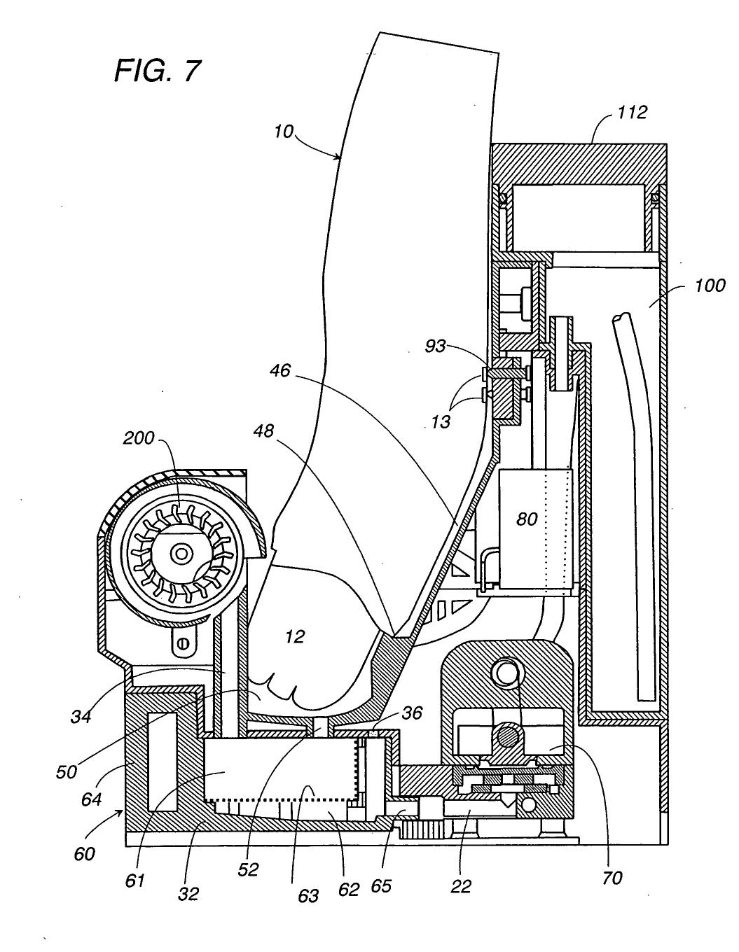

The device further includes a filter detector 98 which issues a stop signal when the drip pan 60 is not in position below the basin 50. In response to the stop signal, the controller 92 deactivates the pump 70 and the associated parts to cease the above operation. A display 96 is included in the device to give information about which one of the supply mode and the recovery mode is proceeding, and the elapsed time. Further, a signal transmitting terminal 91 is provided on the side of the housing 20 for transmitting an electric signal that is received in a shaver controller 14 to activate the shaver head 12 or a charging circuit 16 for charging a battery 15. As best shown in FIGS. 6 and 7, the terminal 91 includes a set of contacts 93 exposed on the front wall of the stand 40 for contact with a corresponding set of pads 13 formed on the exterior of the shaver 10. The pads defines a signal receiving terminal 11 represented in FIG. 5 through which the signal is transmitted to the shaver controller 14. The contacts 93, i.e., the terminal 91 is located intermediate the height of the stand 40 for intimate contact with the pads 13 or the receiving terminal 11 when the shaver 10 is held upside down to place the shaver head 12 into the basin 50. Alternatively, the signal transmitting terminal 91 may be in the form of a primary winding for transformer coupling with a secondary winding placed within the shaver as the signal receiving terminal 11. In this modification, both of the windings can be concealed within the housing and shaver, respectively.

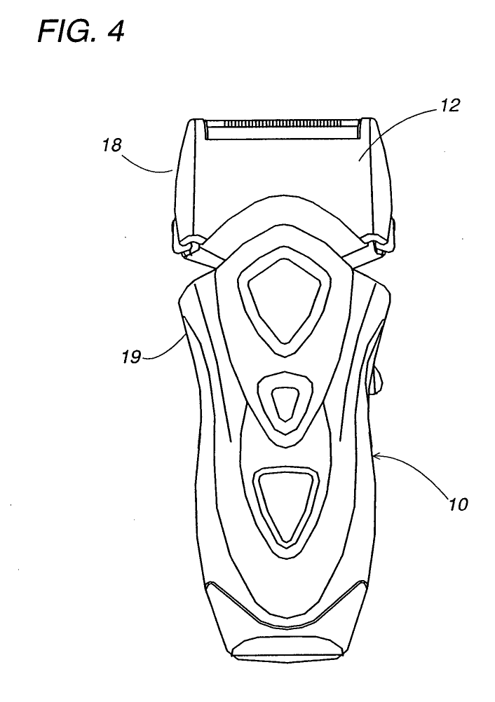

As shown in FIG. 6, the stand 40 carries a holding means, i.e., a mechanism of holding the shaver 10 in position. The mechanism includes a pair of clasps 42 which are spaced widthwise with respect to the height dimension of the housing 20 and are pivotally supported to the stand 40 to be movable between a holding position of bracing the shaver 10 and a releasing position permitting the removable of the shaver. The clasps 42 are biased by coil springs 43 to the holding position in which the clasps 42 engage the opposite sides of the shaver 10. Each of the clasps 42 is formed at its upper and lower end respectively with inclined guides 44 for sliding contact with tapered head sides 18 as well as top tapered sides 19 adjacent to the shaver head 12, as shown in FIG. 4. Thus, the clasps 42 can be forced to open temporarily in the release position when the shaver is moved vertically to place the shaver head 12 into the basin 50, allowing the easy attachment of the shaver, after which the clasps close by the action of the springs into the holding position. Also, when the shaver is moved vertically to pull the shaver head 12 out of the basin 50, the clasps 42 are forced to open by contact with the top tapered sides 19 of the shaver, permitting the easy detachment of the shaver from the device. In the holding position, the clasps 42 urges the shaver 10 towards the stand 40 in order to keep the pads 13 of the receiving terminal 11 pressed against the corresponding contacts 93 for reliable signal transmission therebetween.

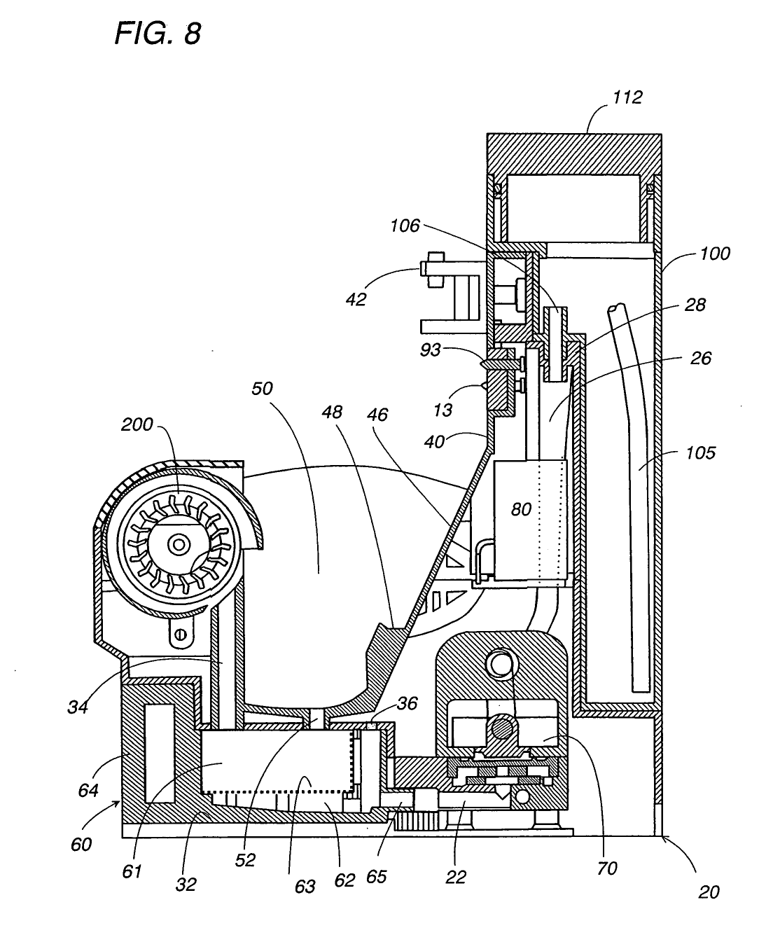

As shown in FIGS. 7 to 9, the stand 40 has a front face which is configured to guide the apparatus 10 to a holding position where the shaver head 12 is received within the basin 50. For this purpose, the front face has is a guide face 46 which is inclined with respect to a vertical or height axis of the housing 20 and which is formed at its lower end with a stopper 48 for abutting against a shoulder of the apparatus or shaver 10. The stopper 48 is positioned so that the apparatus 10 is caused to lean upon the front face of the stand by its own weight, thereby urging the pads 13 of the receiving terminal 11 against the contacts 93 of the transmitting terminal 91 for reliable electrical contact therebetween. In this sense, the electrical connection can be made successfully even without relying upon the springs 43 of the clasps 42.

The drip pan 60 is made detachable to the housing 20 for easy cleaning of the filter 63 as well as the pan 60 itself. As shown in FIGS. 7, 8, and 14, the drip pan 60 is provided in the form of a drawer having a front handle 64 and the top opening which comes into fluid communication with the drain port 52 of the basin 50, the air vent 36, and the overflow duct 34 for receiving the liquid and/or the air therethrough. A recess 32 is formed at the front end of the base 30 immediately below the basin 50 to accommodate the drip pan 60. The inner bottom of the pan 60 is inclined downwardly towards the connection port 65 for smoothly guiding the liquid to the fluid intake channel 22. As shown in FIG. 14, the interior space of the drip pan 60 is divided by the filter 63 into a first chamber 61 and a second chamber 62. The first chamber 61 is in direct open communication with the drain port 52 and the overflow duct 34 for collecting the liquid and/or the air respectively therethrough, thereby depositing the contaminants carried by the liquid on the filter 63. The second chamber 62 is in direct open communication with the air vent 36 and with the connection port 65 for feeding the liquid cleared of the contaminants as well as the outside air into the fluid intake channel 22. For this purpose, the filter 63 is bent into an L-shaped section, as shown in FIG. 14. With this arrangement, the vertical portion of the filter 63 can be located above the level of the liquid in the drip pan 60 so as to entrap the contaminants possibly carried by the air drawn through the drain port 52 in the initial stage of the supply mode as well as in the last stage of the recovery mode.

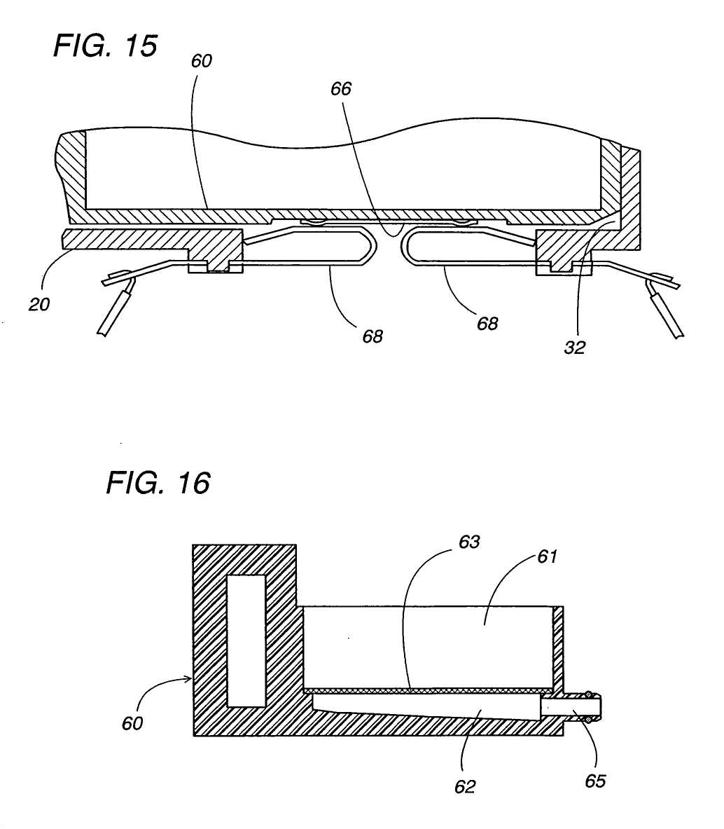

As shown in FIG. 15, the drip pan 60 is formed with an electrode 66 which comes into contact with corresponding leads 68 at the bottom of the housing 20 when the drip pan 60 is received in the recess 32 of the housing 20. The electrode 66 and the leads 68 constitute a switch which opens in response to the drip pan 60 being removed from the position below the basin 50. The switch is electrically connected to the filter detector 98 which issues an enable signal to the controller 92 only when the drip pan is in the correct position, allowing the pump to be activated only in this condition. The drip pan 60 is designed to have a liquid storing capacity larger than that of the basin 50 in order to collect the entire volume of the liquid from the basin 50 even if the pump 70 should stop during the supply mode. The filter is preferred to have a filtering area of 700 mm² or more. Further, instead of providing the removable drip pan 60, the filter 63 alone may be detachable to the housing for frequent cleaning purpose. Alternatively, the filter 63 may be made flat, as shown in FIG. 16, so that the second chamber 62 communicates with the air vent 36 through the filter 63. In this modification, the filter 63 can entrap contaminants carried by the air drawn also through the air vent 36.

The cleaning device in accordance with the present invention can be equally applied for cleaning the epilating head of a hand-held epilator or other operator head of similar hair removing apparatus.

1. A cleaning device for a hair removing apparatus, said device comprising:
a housing having a basin that receives an operator head of the hair removing apparatus;
a tank storing a volume of a cleaning liquid:
a pump supplying the cleaning liquid from said tank to said basin for cleaning the operator head of the apparatus;
a drip pan being formed separately from said tank and being disposed underneath said basin to collect the liquid dripping from the basin, said drip pan being connected to said tank by way of a fluid intake channel for allowing the liquid to return from within said drip pan to said tank under the action of said pump,
said drip pan being open to the bottom of said basin for collecting hairs or contaminants dislodged from the operator head,
wherein
said drip pan is provided with a filter for removing the hair and the contaminants from the liquid.

2. The cleaning device as set forth in claim 1, wherein
said drip pan is separated by said filter into a first chamber which is in direct communication with said basin and a second chamber having a connection port for direct connection with said fluid intake channel,
said connection port having a flow cross area smaller than the surface area of said filter.

3. The cleaning device as set forth in claim 1, wherein
said drip pan is separated by said filter into a first chamber which is in direct communication with said basin and a second chamber in direct communication with said fluid intake channel,
said second chamber communicating with an air vent that is formed in said housing and is open to the atmosphere not through the filter for introducing an outside air,
said tank being in the form of a hermetically sealed container which is selectively open to the atmosphere by way of an air valve,
said device including a controller that selectively provides a supply mode for supplying the liquid to said basin from said tank and a recovery mode for recovering the liquid from said basin to said tank,
said supply mode actuating said pump while keeping said air valve closed so as to feed the air introduced through said air vent into said tank by way of said fluid intake channel and accumulate the air pressure within said tank, thereby forcing the liquid out of said tank to said basin,
said recovery mode actuating said pump while keeping said air valve opened to feed the liquid out from said basin through said fluid intake channel to said tank without accumulating the air pressure within said tank, thereby collecting the liquid into the tank.

4. The cleaning device as set forth in claim 1, wherein
said drip pan is removable received within a recess formed in said housing below said basin.

5. The cleaning device as set forth in claim 1, wherein
said drip pan is separated by said filter into a first chamber which is in direct communication with said basin and a second chamber having a connection port for direct connection with said fluid intake channel,
said filter having an upper area and a lower area, said upper area being configured to be positioned above a level of the liquid dripped and stored into said drip pan for introducing the air through said upper area into said second chamber,
said tank being in the form of a hermetically sealed container which is selectively open to the atmosphere by way of an air valve,
said device including a controller that selectively provides a supply mode for supplying the liquid to said basin from said tank and a recovery mode for recovering the liquid from said basin to said tank,
said supply mode actuating said pump while keeping said air valve closed so as to feed the air introduced through said upper area of said filter into said tank by way of said fluid intake channel and accumulate the air pressure within said tank, thereby forcing the liquid out of said tank to said basin,
said recovery mode actuating said pump while keeping said air valve opened to feed the liquid out from said basin through said fluid intake channel to said tank without accumulating the air pressure within said reservoir, thereby collecting the liquid into the tank.

6. The cleaning device as set forth in claim 1, wherein
said drip pan is separated by said filter into a first chamber which is in direct communication with said basin and a second chamber having a connection port for direct connection with said fluid intake channel,
said second chamber having an inner bottom which is inclined downwardly to said connection port.

7. The cleaning device as set forth in claim 1, wherein
said drip pan is configured to have a liquid storing capacity larger than that of said basin.

8. The cleaning device as set forth in claim 4, further including a monitor that monitors whether or not said drip pan is attached to said housing,
said controller deactivating said pump in response to said drip pan being detached from said housing.

9. The cleaning device as set forth in claim 1, wherein
said filter is removable from said housing.

10. The cleaning device as set forth in claim 9, further including
said housing includes a controller that activates said pump and a monitor that monitors whether or not said filter is attached to said housing,
said controller deactivating said pump in response to said filter being detached from said housing.
